(19) United States
(12) Patent Application Publication
(10) Pub. No.: US 2004/0144275 A1
(43) Pub. Date: Jul. 29, 2004

(54) Cylinder of a printing machine

(76) Inventors: Kurt Johannes Weschenfelder, Zell/Main (DE); Hans Dierk Mohrmann, Greussenheim (DE)

Correspondence Address: Douglas R Hanscom, Jones Tullar & Cooper, Eads Station, PO Box 2266, Arlington, VA, 22202, US

(21) Appl. No.: 10/475,093

(22) PCT Filed: Feb. 20, 2002
(86) PCT No.: PCT/DE02/00605

(30) Foreign Application Priority Data
Apr. 27, 2001 (DE) 101 20 958.4

(51) Int. Cl. B41F 31/26

(52) U.S. Cl. 101/351.6

(57) ABSTRACT

The invention relates to a cylinder for a rotary printing machine, whose peripheral surface has at least two cylindrical segments (07, 08) next to one another, which are separated from one another by a groove (09) located therebetween, wherein the groove can be closed by an inlay element (11, 12) that can be releasably fixed to form a continuos surface area. The inlay element is formed by several parts, especially two inlay parts, whose peripheral surfaces complement each other to form a cylindrical peripheral surface after the inlay part has been placed in the groove.

The invention relates to a roller of a printing press in accordance with the preamble of claim 1 or 10.

Rollers in accordance with the species can be employed, however not exclusively, as ink transport rollers, for example inking rollers, ink ductors, application rollers or distributing rollers in inking systems, which can be changed from panoramic printing to printing in several colors next to each other. Panoramic printing is understood to be the printing of an image over two pages without a break. With a printing press of the width of four pages it is therefore possible during panoramic printing to print two panoramic images, each extending over two pages. When changing a printing group from panoramic printing to printing in several colors next to each other, or vice versa, various retooling procedures are required at the inking system, depending on its type.

To reduce the required retooling work, ink transport rollers are known from DE 196 28 647 A1, wherein the recesses between the individual cylinder-shaped sections of the inking roller can be selectively closed off. In accordance with an embodiment described, a strip-shaped insertion element is used for this, which is clamped on the roller and closes off the recess. In this case the strip-shaped insert element can be made either of plastic with a sufficiently high heat expansion coefficient, so that the strip, after having been heated in a water bath, can be mounted on the roller and thereafter is clamped and closes the recess while cooling. Alternatively to this it is also possible to employ steel strips with copper surfaces, which can also be clamped on the roller in the state by applying mechanical clamping forces.

U.S. Pat. No. 0,795,858 shows an inking roller whose barrel has two sections separated by a groove. This groove can be closed off by means of two half shells.

The object of the invention is based on creating a roller for a printing press.

In accordance with the invention, this object is attained by the characteristics of claim 1 or 10.

An advantage to be gained by means of the invention lies in particular in that, because of the multiple embodiment of the insertion element, it is possible to produce an insertion element which can be greatly mechanically stressed and produced geometrically very exactly. With the strip-shaped insertion elements known from the prior art it was required for mounting the insertion elements on the roller to deform the insertion elements at least slightly. Accordingly, the insertion element could only have a defined maximum stability. Because of the divided embodiment of the insertion element in the manner of several insertion parts which complement each other into forming a cylinder-shaped circumferential surface, it is possible to omit the deformation of the individual insertion parts in the course of mounting, or dismounting the insertion parts.

An exemplary embodiment of the invention is represented by way of example in the drawings and will be described in greater detail in what follows.

Shown are in:

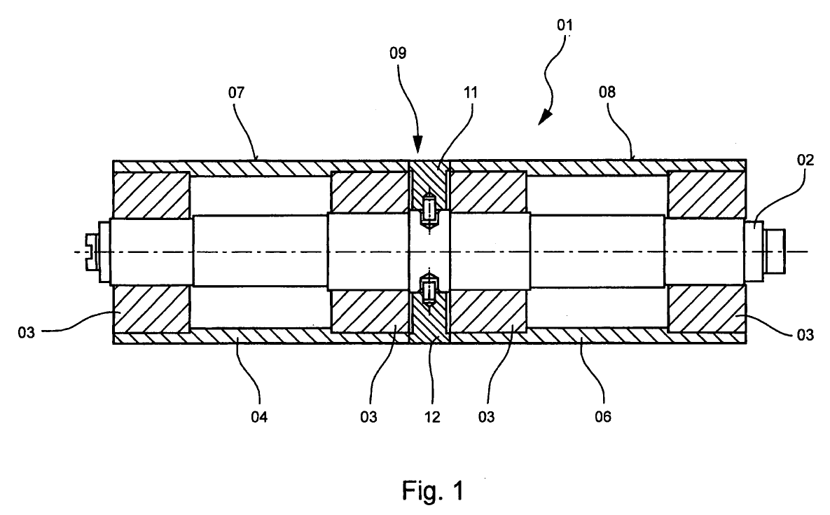

FIG. 1, a cross section through a roller,

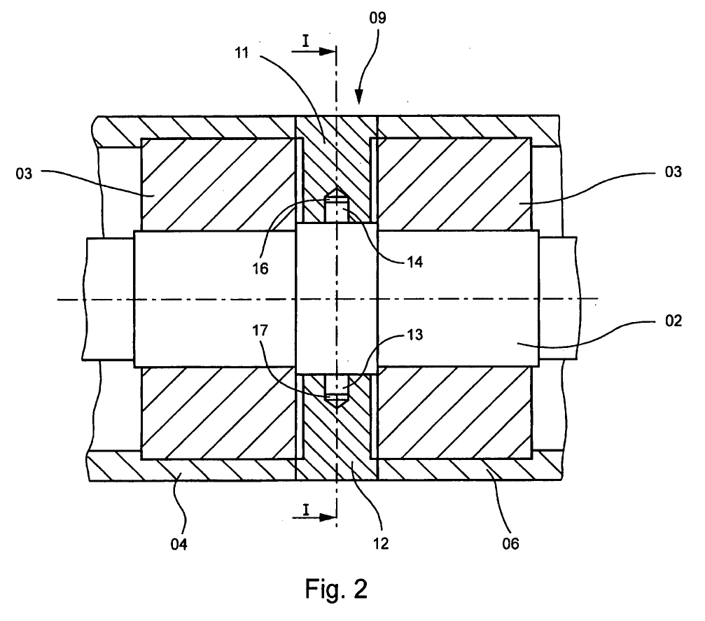

FIG. 2, an enlarged portion of the cross section represented in FIG. 1,

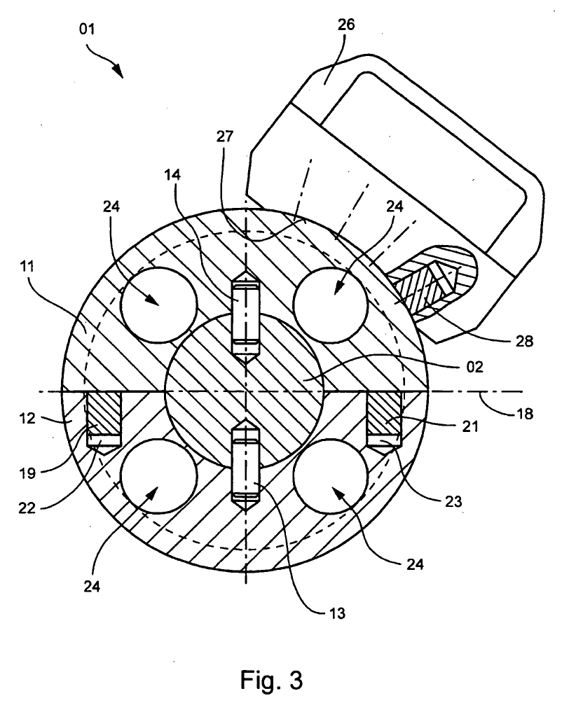

FIG. 3, a section through the roller in FIG. 2 along the line I-I.

A roller 01 is represented in FIG. 1, which can find use as an ink ductor arranged in an ink duct of a rotary printing press. A continuous shaft 02 is provided for seating the roller 01 in a frame, not represented. Two tube-shaped cylinder elements 04, 06 are seated on the roller 02 by means of four hubs 03, which are seated next to each other. The jacket surfaces 07, 08 of the cylinder elements 04, 06 form two cylinder-shaped sections 07, 08, which are separated from each other by a centrally arranged groove 09, for example a recess 09, so that different colored inks are not inadvertently intermixed.

In the representation of FIG. 1, an insertion element formed by two insertion elements 11, 12, for example two insertion parts 11, 12, is arranged in the recess 09 and completely closes the recess 09. The exterior diameter of the insertion element formed by the insertion parts 11, 12 has been selected here in such a way that the circumferential faces of the insertion parts 11, 12 complement each other and form a cylinder-shaped circumferential face. The cylinder-shaped circumferential face of the insertion elements makes a clean transition into the circumferential faces of the cylinder-shaped sections 07, 08, so that as a result a continuous jacket surface is formed by the arrangement of the insertion parts 11, 12 in the recess 09. This continuous jacket surface can be used for ink transport of an ink during panoramic printing. If the roller 01 is to be retooled for multi-color printing, the insertion parts 11, 12 can be simply removed, so that separate sections 07, 08 for the application of different colors are again provided.

FIG. 2 shows the arrangement of the insertion parts 11, 12 in the recess 09 in an enlarged representation. For transmitting a torque between the shaft 02 and insertion part 11, 12, bolt-shaped take-along elements 13, 14 are fastened on the circumference of the shaft 02, which can engage recesses 16, 17 in the insertion parts 11, 12. The take-along elements 13, 14 have different diameters, so that the insertion parts 11, 12 can be mounted in only one installed position on the shaft 02. By means of this it is assured that the ground functional surfaces come to rest against each other in the correct position.

FIG. 3 shows the roller 01 in a section along the section line I-I. The two insertion parts 11, 12 can be seen, each of which is embodied in the manner of half a circular disk and complement each other to form a circular disk whose interior diameter corresponds to exactly the exterior diameter of the corresponding shaft section of the shaft 02, and whose exterior diameter corresponds to exactly the exterior diameter of the cylindrical sections 07, 08. The insertion element constituted of the insertion parts 11, 12 can be separated at a level separating seam 18, so that the insertion parts 11, 12 can be mounted, or dismounted, by means of a simple linear joining movement.

Two bolt-like magnetic elements 19, 21, which are fastened in the recesses 22, 23, are provided on the insertion part 12 for fixing the insertion parts 11, 12 in place on the shaft 02. The magnetic force of the magnetic elements 19 or 21 acts on the insertion parts 11, 12 via the separating seam 18, so that the insertion parts 11, 12 are non-positively held together with the shaft 02.

To reduce the centrifugal forces acting on the insertion parts 11, 12 during the rotation of the roller 01, continuous recesses have been cut into the insertion parts 11, 12 parallel with the jacket surface of the roller 01.

Since the insertion parts 11, 12 are kept together by means of the inside located magnetic elements 19, 21, a circumferential face substantially free of grooves can be realized on the circumference of the insertion parts 11, 12. This circumferential face is only interrupted by the separating seam 18, wherein this interruption can be reduced to a tolerable amount by an appropriate grinding of the contact surfaces lying on top of each other. For dismounting the insertion parts 11, 12, no conventional tool can be employed because of the lack of engagement faces on the circumference. Therefore a handle 26 is used for dismounting the insertion parts 11, 12, which can be brought into positive contact with a concave functional surface 27 on the cylinder-shaped circumferential face of the insertion parts 11, 12. So that, as represented in FIG. 3, the insertion part 11 can be pulled radially outward while overcoming the magnetic forces exerted by the magnetic elements 19, 21, a magnetic element 28 is provided on the handle 26. A pull-off force can be non-positively transmitted from the handle 26 to the insertion part 11 by means of the magnetic field of the magnetic element 28 designed in the manner of a permanent magnet. The oppositely located insertion part 12 only needs to be pulled off radially outward after the insertion part 11 has been pulled off.

### List of Reference Symbols

01 Roller

02 Shaft

03 Hub

04 Cylinder element

05 -

06 Cylinder element

07 Jacket surface, section

08 Jacket surface, section

09 Groove, recess

10 -

11 Insertion element, insertion part

12 Insertion element, insertion part

13 Take-along element

14 Take-along element

15 -

16 Recess

17 Recess

18 Separating seam

19 Magnetic element

20 -

21 Magnetic element

22 Recess

23 Recess

24 Recess

25 -

26 Handle

27 Functional element, concave (26)

28 Magnetic element

1. A roller (01) of a printing press, whose circumferential face has at least two cylinder-shaped sections located next to each other, which are separated from each other by a groove (09) located between them wherein, for forming a continuous jacket surface (07, 08, 11), the groove (09) can be closed off by at least one removable insertion part (11, 12), characterized in that the insertion part (11, 12) is magnetically maintained in the groove (09).

2. The roller in accordance with claim 1, characterized in that two insertion parts (11, 12) are arranged, and that the insertion parts (11, 12) are designed in the manner of two circular half disks.

3. The roller in accordance with claim 1, characterized in that the insertion part (11, 12) is made of metal, in particular of steel.

4. The roller in accordance with one of claims 1 to 3, characterized in that at least one magnetic element (19, 21) is arranged on the insertion part (11, 12) and/or on the roller (01), by means of which the insertion part (11, 12) can be fixed in place in the recess (09).

5. The roller in accordance with claim 4, characterized in that the magnetic element (19, 21) is fastened in the recesses (23, 24).

6. The roller in accordance with one of claims 1 to 5, characterized in that recesses (24) extending parallel with the jacket surface of the roller (01) are provided in the insertion part (11, 12).

7. The roller in accordance with one of claims 1 to 6, characterized in that at least one protruding take-along element (13, 14) is fastened on the roller (01) or on the insertion part (11, 12), which engages an oppositely located recess (16, 17) in the roller (01) or in the insertion part (11, 12).

8. The roller in accordance with claim 7, characterized in that a take-along element (13, 14) can be brought into respective engagement with each insertion part (11, 12), wherein the take-along elements (13, 14) have different dimensions.

9. The roller in accordance with one of claims 1 to 8, characterized in that the roller (01) is embodied as an inking roller, in particular an ink ductor.

10. A roller (01) of a printing press, whose circumferential face has at least two cylinder-shaped sections located next to each other, which are separated from each other by a groove (09) located between them wherein, for forming a continuous jacket surface (07, 08, 11), the groove (09) can be closed off by at least one removable insertion part (11, 12), characterized in that a handle (26) is magnetically fastened at times on the insertion part (11, 12).

11. The roller in accordance with claim 10, characterized in that at least one magnetic element (28) is provided on the handle (26).

12. The roller in accordance with claim 10, characterized in that the handle (26) has a concave functional surface (27), which can be brought into positive contact with the cylindrical circumferential face of an insertion part (11, 12).
